(19) United States
(12) Patent Application Publication
(10) Pub. No.: US 2008/0316959 A1
(43) Pub. Date: Dec. 25, 2008

(54) METHOD OF TRANSMITTING SCHEDULING REQUESTS OVER UPLINK CHANNELS

(76) Inventors: Rainer Bachl, Nuremberg (DE); Matthias Schneider, Nuremberg (DE); Jung A. Lee, Pittstown, NJ (US)

Correspondence Address: MARK W. SINCELL;Williams, Morgan & Amerson, P.C., Suite 1100, 10333 Richmond, Houston, TX, 77042, US

(21) Appl. No.: 11/765,063

(22) Filed: Jun. 19, 2007

(51) Int. Cl. H04Q 7/20

(52) U.S. Cl. 370/329

(57) ABSTRACT

In various embodiments of the present invention, methods are provided for transmitting scheduling requests over uplink channels. One embodiment includes determining whether a first resource for transmission of a scheduling request over an unscheduled uplink control channel is allocated concurrently with a second resource for transmission of user data over a scheduled uplink shared channel. This embodiment also includes encoding the user data and bit(s) of control information to form encoded information for transmission using the second resource. The additional bit(s) indicate whether the mobile unit is transmitting the scheduling request. Another embodiment includes determining whether a first resource for transmission of a scheduling request over an unscheduled uplink control channel is allocated concurrently with a second resource for transmission of other control information over the unscheduled uplink control channel. This embodiment includes modulating the scheduling request and the other control information into one symbol for transmission using the first resource.

### BACKGROUND OF THE INVENTION

1. Field of the Invention

This invention relates generally to communication systems, and, more particularly, to wireless communication systems.

2. Description of the Related Art

The coverage area of a wireless communication system is typically divided into a number of cells or sectors, which may be grouped into one or more networks. Base stations provide wireless connectivity to the cells or sectors within the wireless communication system. Alternatively, wireless connectivity may be provided by access points, base station routers, access networks, and the like. Mobile units located in each cell may access the wireless communications system by establishing a wireless communication link, often referred to as an air interface, with the base station associated with the cell or sector. The mobile units may also be referred to using terms such as access terminal, user equipment, subscriber station, and the like. The mobile units may include devices such as mobile telephones, personal data assistants, smart phones, Global Positioning System devices, wireless network interface cards, desktop or laptop computers, and the like.

The wireless communication link typically includes one or more downlink (or forward link) channels for transmitting information from the base station to the mobile unit and one or more uplink (or reverse link) channels for transmitting information from the mobile unit to the base station. The uplink and downlink channels include data channels for transmitting data traffic, signaling or control channels to carry control information that is used to decode the data channels, paging channels for locating mobile units, broadcast channels for broadcasting information to multiple mobile units, multicast channels for broadcasting information to a subset of mobile units that have subscribed to the multicast service, and the like. The channels may be shared by multiple mobile units or dedicated to one mobile unit at a time. Channels can be defined using different time slots (e.g., Time Division Multiple Access or TDMA), frequencies (e.g., Frequency Division Multiple Access or FDMA), code sequences (e.g., Code Division Multiple Access or CDMA), orthogonal subcarrier frequencies or tones in a carrier frequency band (e.g., Orthogonal Frequency Division Multiplexing or OFDM), or combinations thereof.

Each base station typically provides wireless connectivity to more than one mobile unit. Consequently, air interface resources are shared between the multiple mobile units. For example, mobile units may share one or more uplink channels to a base station. When a mobile unit has information to transmit over the uplink channel, such as a data burst, the mobile unit transmits a scheduling request to request access to the uplink channel. The mobile unit then waits to transmit information over the uplink channel until after receiving an access grant from the base station. The access grant typically indicates the resources that have been allocated to the mobile unit to transmit the information, such as a timeslot, a channel code, a frequency or tone, and the like. The mobile unit relinquishes the channel once the data burst has been transmitted. Base stations that implement these so-called schedule-on-demand or bandwidth-on-demand schemes can control access to the uplink channel to prevent collisions between different mobile units attempting to transmit over the same uplink channel. The base station may also schedule access to the air interface resources to take advantage of fluctuations in channel conditions.

In next generation wireless systems like the Universal Mobile Telecommunication System (UMTS) Long-Term Evolution, mobile units are required to transmit certain types of control messages in a portion of the uplink and downlink data that is transmitted in an unscheduled mode that is distinct from a scheduled mode that may be used to transmit other portions of the user and control data that are scheduled explicitly by the base station system. For example, systems like UMTS-LTE implement physically different channels for scheduled user and control data (e.g., the physical uplink shared channel or PUSCH) and unscheduled control data (e.g., the physical uplink control channel or PUCCH) that are transmitted in different frequency bands or sub-bands and may make use of different modulation and coding schemes. Time and frequency resources may be pre-allocated to both the scheduled and unscheduled channels. However, due to constraints on the peak-to-average power of the transmitter, the UMTS-LTE standards specify that information cannot be transmitted concurrently on the scheduled and unscheduled channels by the same mobile unit. For example, when a mobile unit is scheduled to transmit data via the PUSCH in a specific timeslot, it may not send control data concurrently via the PUCCH. The mobile units can transmit via the scheduled PUSCH only when explicitly signaled by the scheduler from the base station system, but the mobile units can use the PUCCH at regular pre-allocated time intervals.

Three types of control information are typically transmitted over unscheduled uplink data channels such as the PUCCH defined in UMTS-LTE. Acknowledgement and/or Non-Acknowledgement (ACK/NAK) messages may be transmitted over the uplink in response to receiving downlink data from a base station. An ACK message is transmitted to acknowledge successful reception of each downlink block of data is acknowledged on correct reception and a NACK message is sent if a failure is detected during the reception. The NACK messages may trigger a retransmission of the unsuccessfully received data. Channel Quality Information (CQI) that indicates the quality of signals received on the downlink is transmitted over the uplink at predetermined periodic intervals. Mobile units may also transmit scheduling requests over the uplink in order to request resources in the scheduled data channels such as the PUSCH. For example, a mobile unit may transmit a scheduling request when its transmit buffer is filled.

Timing of the uplink control data transmissions must be known to both the base station and the mobile units. In conventional wireless communication systems, the ACK/NACK messages are transmitted over the scheduled uplink channel a selected amount of time after the associated downlink transmission. Both the mobile unit and the base station know the value of the delay between reception of a downlink data block and transmission of the ACK/NACK over the uplink. The CQI is transmitted at regular intervals using a pre-allocated resource. For example, the CQI may be transmitted in predetermined time slots using a predetermined group of subcarriers and code sequence. Thus, the base station knows when the mobile unit will be transmitting CQI over the uplink. Uplink channel resources are also pre-allocated for transmission of scheduling requests, but the scheduling requests are only transmitted when the mobile unit is requesting uplink resources for data transmission. Thus, the base station cannot predict when the mobile unit will actually transmit a scheduling request.

The control data cannot be transmitted using the unscheduled uplink control channels when user data has been scheduled for transmission in the same timeslot over the scheduled data channels. The control information may therefore be concatenated to the user data that has been scheduled for transmission over the scheduled data channels. In this circumstance, the amount of data that actually has to be transmitted over the scheduled data channels is larger than the requested scheduling grant. The mobile unit can adapt its code rate (also called rate matching, puncturing, and repetition) to squeeze the extra bits into the same physical resource allocation. The base station can decode the received transmission correctly as long as it can predict when the mobile unit will adapt its code rate to transmit additional control information. For example, the base station knows that CQI will be transmitted in the pre-allocated time slot and that ACK/NAK messages will be transmitted at a fixed time after a downlink transmission. The base station can therefore predict when the scheduled data and unscheduled CQI or ACK/NACK messages will collide, thereby forcing the mobile unit to modify its code rate to transmit the combined user data and control data using the scheduled physical resources. The base station can use this prediction to apply the correct decoding algorithms to the received transmission without additional information.

Scheduling requests are transmitted in pre-configured resources known to the base station and the mobile station, but they are only transmitted when the mobile station actually has some data to be transmitted on the uplink. The base station cannot predict when the scheduled data and unscheduled scheduling request will collide. Consequently, the base station cannot predict when the mobile unit will modify its code rate to transmit the combined user data and control data (i.e., the scheduling request) using the scheduled physical resources. Instead, the base station has to “blind decode” the message by applying all possible combinations of code rate parameters (such as puncturing or repetition parameters) and check whether it has received valid data at each assumed code rate. Blind decoding is much more complex than conventional decoding using a known code rate. Thus, blind decoding consumes more time and requires more complex hardware, firmware, and/or software to implement.

Different types of control data may also collide. For example, CQI and scheduling requests are transmitted in pre-allocated time-intervals on the unscheduled uplink channels. However, the ACK/NAK messages are transmitted over the uplink a fixed time after a transmission is received over the downlink. Thus, the ACK/NAK and the scheduling request may have to be transmitted over the unscheduled uplink channel in the same allocated time interval. The ACK/NAK and the scheduling request may be code-multiplexed onto the unscheduled uplink channels. However, code-multiplexing the ACK/NAK and the scheduling request would increase the peak-to-average power ratio, which is undesirable.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In various embodiments of the present invention, methods are provided for transmitting scheduling requests over uplink channels. One embodiment includes determining whether a first resource for transmission of a scheduling request over an unscheduled uplink control channel is allocated concurrently with a second resource for transmission of user data over a scheduled uplink shared channel. This embodiment also includes encoding the user data and at least one bit of control information to form encoded information for transmission using the second resource. The additional bit(s) indicate whether the mobile unit is transmitting the scheduling request. Another embodiment includes determining whether a first resource for transmission of a scheduling request over an unscheduled uplink control channel is allocated concurrently with a second resource for transmission of other control information over the unscheduled uplink control channel. This embodiment includes modulating the scheduling request and the other control information into one symbol for transmission using the first resource.

### BRIEF DESCRIPTION OF THE DRAWINGS

The invention may be understood by reference to the following description taken in conjunction with the accompanying drawings, in which like reference numerals identify like elements, and in which:

FIG. 1 shows one exemplary embodiment of a wireless communication system, in accordance with the present invention;

FIG. 2 conceptually illustrates the timeslot structure of a scheduled uplink channel and an unscheduled uplink channel, in accordance with the present invention;

FIG. 3 conceptually illustrates the timeslot structure of an unscheduled uplink channel, in accordance with the present invention; and

FIG. 4 conceptually illustrates one exemplary embodiment of a decision tree hat may be used for the selection of transmission means of the scheduling request, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

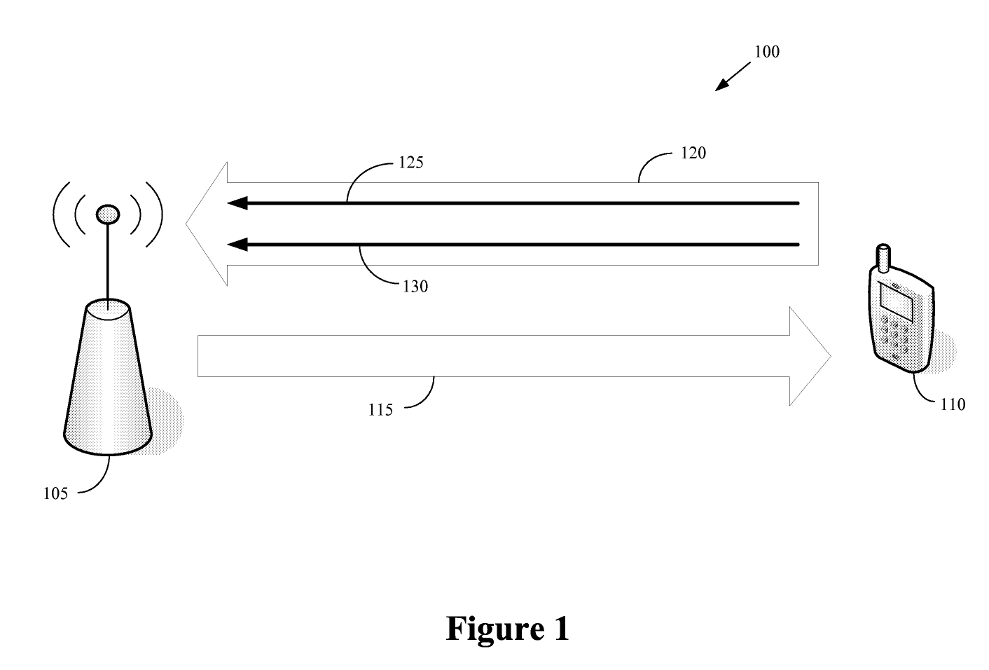

FIG. 1 conceptually illustrates one exemplary embodiment of a wireless communication system 100. In the illustrated embodiment, the wireless communication system includes one or more base stations 105 for providing wireless connectivity. Although a single base station 105 is depicted in FIG. 1, persons of ordinary skill in the art having benefit of the present disclosure should appreciate that alternate embodiments of the wireless communication system 100 may include any number of base stations 105. Furthermore, other devices may alternatively be used to provide wireless connectivity. Exemplary devices for providing wireless connectivity include access points, accessing serving networks, access networks, base station routers, and the like. In various embodiments, the functionality of the base stations 105 may be implemented in hardware, firmware, software, or any combination thereof.

The base station 105 may provide wireless connectivity to one or more mobile units 110. Although a single mobile unit 110 is depicted in FIG. 1, persons of ordinary skill in the art having benefit of the present disclosure should appreciate that alternate embodiments of the wireless communication system 100 may include any number of mobile units 110. Mobility does not necessarily imply portability and exemplary mobile units 110 may include cellular telephones, personal data assistants, smart phones, pagers, text messaging devices, network interface cards, notebook computers, desktop computers, and the like. In various embodiments, the functionality of the mobile units 110 may be implemented in hardware, firmware, software, or any combination thereof.

In the illustrated embodiment, a wireless communication link has been established between the base station 105 and the mobile unit 110. The wireless communication link includes a downlink 115 and an uplink 120. The downlink 115 may include one or more data, control, paging, and/or broadcast channels (not shown in FIG. 1) and the uplink 120 may include one or more scheduled uplink channels 125 and one or more unscheduled uplink channels 130. For example, a wireless communication system 100 may implement scheduled channels 125 for transmitting scheduled user and control data (e.g., a physical uplink shared channel or PUSCH) and unscheduled channels 130 for transmitting unscheduled control data (e.g., the physical uplink control channel or PUCCH). The scheduled and unscheduled channels 125, 130 may be transmitted in different frequency bands or sub-bands and may make use of different modulation and coding schemes. In one embodiment, the mobile unit 110 may not transmit information concurrently on the scheduled channels 125 and the unscheduled channels 130.

The mobile unit 110 may transmit scheduling requests to the base station 105 over the unscheduled uplink channel(s) 130. In one embodiment, uplink resources including a portion of a timeslot are pre-allocated to the mobile unit 110 for transmitting scheduling requests over the unscheduled uplink channel 130. However, the mobile unit 110 may not be able to transmit a scheduling request during the pre-allocated portion of the time slot if data and/or control information is scheduled for transmission during the same time slot over one or more of the scheduled uplink channels 125. The mobile unit 110 may therefore add one or more additional bits to the data that is scheduled for transmission over the scheduled uplink channels 125 whenever the resources allocated for transmission of the scheduling requests over the unscheduled uplink channel 130 overlap with the resources allocated for transmission of data over the scheduled uplink channels 125. In one embodiment, the mobile unit 110 uses one coding algorithm or coding rate to encode the data and/or control information for transmission over the scheduled uplink channels 125 and a different coding algorithm or coding rate to encode the data and/or control information with the additional bit(s) indicative of the scheduling request. The mobile unit 110 may therefore transmit the data and/or control information with the additional scheduling request bit using the resources originally allocated for transmitting only the data and/or control information.

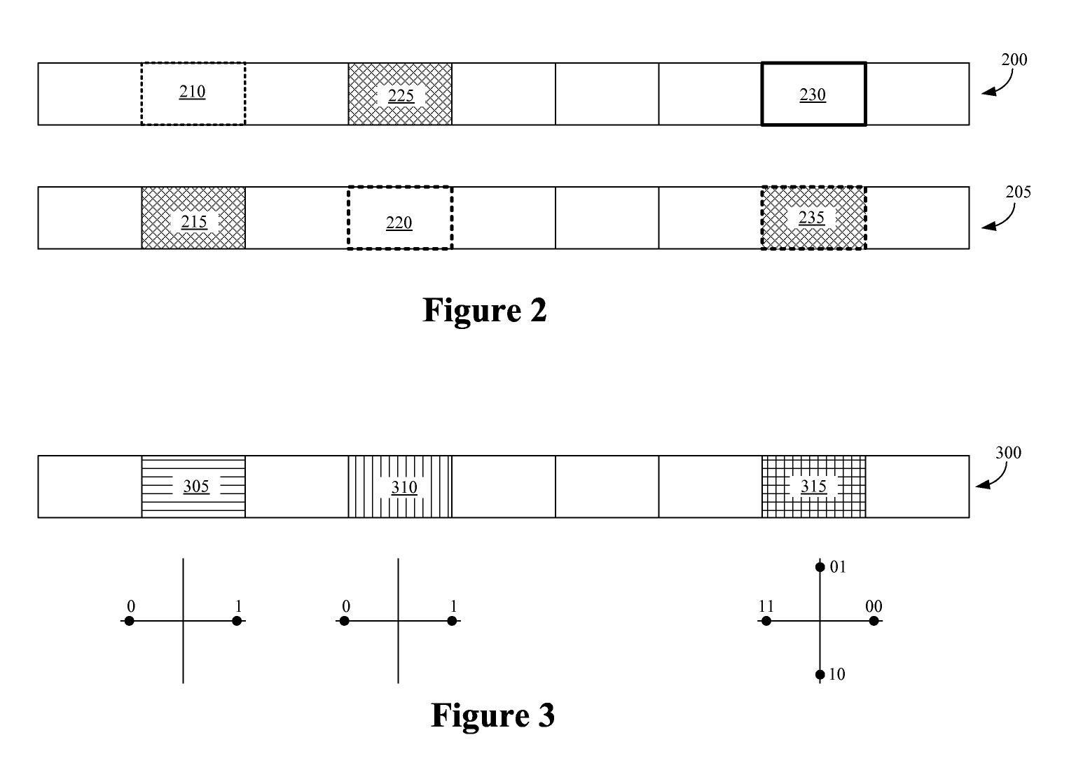

FIG. 2 conceptually illustrates a scheduled uplink channel 200 and an unscheduled uplink channel 205. The channels 200, 205 are divided into a plurality of time slots that may be allocated for transmission of data and/or control information. User data is transmitted in time slot 210 of the scheduled uplink channel 200, as indicated by the dashed bold line, and so no information can be transmitted in the time slot 215 of the unscheduled uplink channel 205, as indicated by the crosshatching. Control information is transmitted in time slot 220 of the unscheduled uplink channel 200, as indicated by the dashed bold line, and so no information can be transmitted in the time slot 225 of the scheduled uplink channel 200, as indicated by the crosshatching.

In the illustrated embodiment, the time slots 230, 235 are allocated for transmitting data and control information over the scheduled uplink channel 200 and the unscheduled uplink channel 205, respectively. Since a mobile unit is not permitted to transmit concurrently over the scheduled uplink channel 200 and the unscheduled uplink channel 205, the coding algorithm used for the data scheduled for transmission in timeslot 230 is modified so that the information scheduled for transmission in the timeslot 235 can be transmitted with the data in the timeslot 230, as indicated by the bold line. No data or control information is transmitted in the timeslot 235, as indicated by the crosshatching.

Referring back to FIG. 1, scheduling requests may also collide with other control information transmitted over the unscheduled uplink channel 130. For example, the mobile unit 110 may need to transmit a scheduling request over the unscheduled uplink channel 130 concurrently with transmitting an acknowledgment or non-acknowledgment message. The mobile unit 110 may therefore be able to transmit information indicative of the scheduling request and the other control information using the resources allocated for transmission of the other control information over the unscheduled uplink channel 130. For example, when the scheduling request collides with an acknowledgment or non-acknowledgment message, the mobile unit 110 may switch from the Binary Phase Shift Key (BPSK) modulation that is typically used to modulate the acknowledgment or non-acknowledgment message to a higher order modulation scheme such as Quadrature Phase Shift Key (QPSK) modulation. Using the higher order modulation scheme increases the size of the constellation of symbol values so that information indicative of both the scheduling request and the acknowledgement or non-acknowledgment message can be transmitted using the resources allocated for transmission of the acknowledgment or non-acknowledgment message without increasing the peak-to-average power ratio.

FIG. 3 conceptually illustrates an unscheduled uplink channel 300. The channel 300 is divided into a plurality of time slots that may be allocated for transmission of data and/or control information. In the illustrated embodiment, a scheduling request is transmitted in the timeslot 305, as indicated by the horizontal hatching. The information indicative of the scheduling request is modulated into one symbol using BPSK modulation to indicate the possible symbol values of 0, which indicates no scheduling requests, and 1, which indicates a scheduling request. An acknowledgment or non-acknowledgment message may be transmitted in the timeslot 310, as indicated by the vertical hatching. The information indicative of the acknowledgment or non-acknowledgment message is modulated into one symbol using BPSK modulation to indicate the possible symbol values of 0 for a non-acknowledgment indicating unsuccessfully received downlink information and 1 for an acknowledgment of successfully received downlink information.

In the illustrated embodiment, a scheduling request and an acknowledgment or non-acknowledgment message are to be transmitted in the timeslot 315. The information indicative of the scheduling request and the acknowledgment or non-acknowledgment is therefore modulated into one symbol using a higher order modulation schemes such as QPSK modulation. Increasing the order of the modulation scheme from binary to quadrature doubles the size of the symbol constellation so that each symbol can represent values of the scheduling request and the acknowledgment or non-acknowledgment message. For example, the symbol value 00 may indicate no scheduling request and a non-acknowledgment indicating unsuccessfully received downlink information. The symbol value 01 may indicate no scheduling request and an acknowledgment indicating successfully received downlink information. The symbol value 10 may indicate a scheduling request and a non-acknowledgment indicating unsuccessfully received downlink information. The symbol value 11 may indicate a scheduling request and an acknowledgment indicating successfully received downlink information.

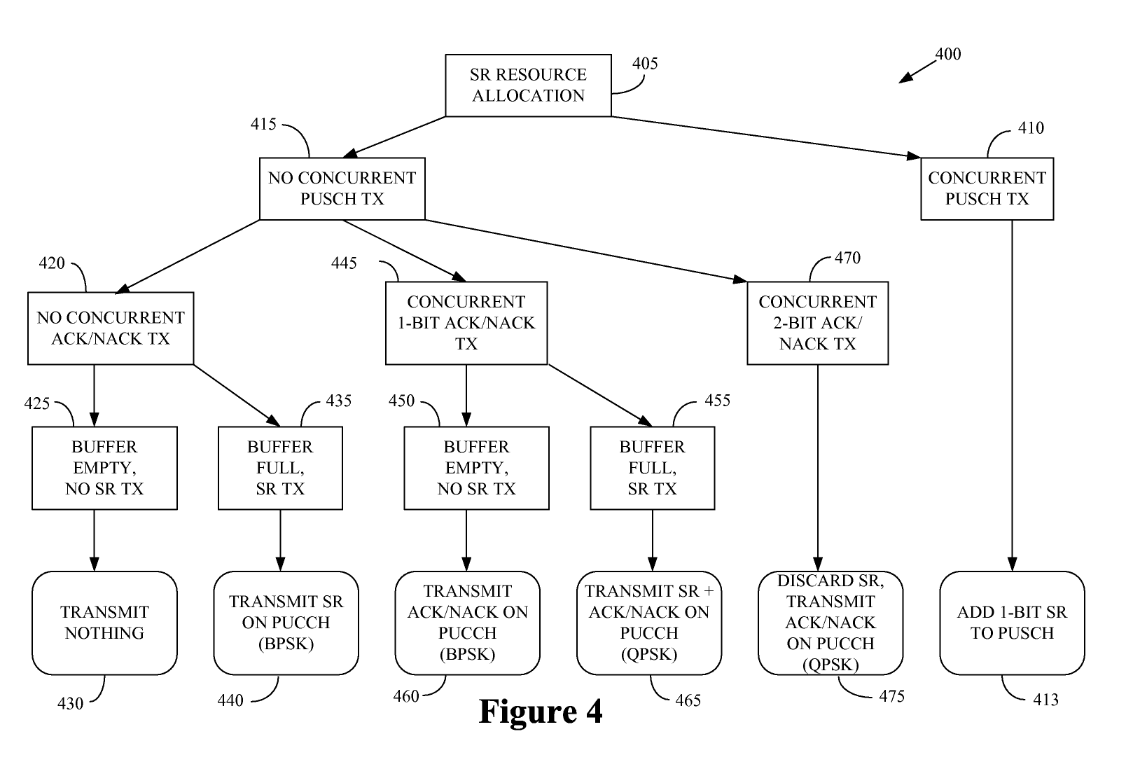

FIG. 4 conceptually illustrates one exemplary embodiment of a decision tree 400 that may be used for transmitting scheduling requests over uplink channels. The embodiment of the decision tree 400 depicted in Figure numeral for may be implemented in the mobile unit. However, persons of ordinary skill in the art having benefit of the present disclosure should appreciate that an analogous decision tree may also be implemented in an associated base station. Consequently, the base station and the mobile unit may operate in a coordinated fashion to transmit and receive scheduling requests over uplink channels because both the base station and the mobile unit have access to the information required to navigate the relevant portions of the decision tree 400.

In the illustrated embodiment, the decision tree 400 begins when a mobile unit allocates (at 405) resources of an unscheduled uplink channel (such as PUCCH) for transmitting a scheduling request (SR). If the mobile unit determines (at 410) that resources are allocated for a concurrent transmission over a scheduled uplink channel, than one or more bits indicative of the scheduling request are added (at 413) to the scheduled uplink channel transmission. This bit or bits may also be added to the scheduled uplink channel data if no scheduling request is pending if the respective timeslot is pre-allocated for the transmission of scheduling requests, however the bit may have a different value to indicate that no scheduling request is pending. The mobile unit may modify the coding algorithm so that the additional bits can be transmitted using the resources allocated for the original scheduled uplink transmission. If the mobile unit determines (at 415) that no resources have been allocated for concurrent transmission over the scheduled uplink channel, then the mobile unit can determine whether or not to transmit a scheduling request using the pre-allocated resources of the unscheduled uplink channel.

If the mobile unit determines (at 420) that there are no concurrent acknowledgment or non-acknowledgment messages to transmit over the unscheduled uplink channel and the mobile unit determines (at 425) that the transmit buffer in the mobile unit is empty or at a relatively low level, then the mobile unit may not transmit (at 430) a scheduling request using the pre-allocated resources of the unscheduled uplink channel. However, if the mobile unit determines (at 435) that the transmit buffer in the mobile unit is full or at a relatively high level, then the mobile unit may transmit (at 440) a scheduling request using the pre-allocated resources. The signaling request may be modulated using a relatively low order modulation scheme such as BPSK.

If the mobile unit determines (at 445) that there is one concurrent acknowledgment or non-acknowledgment message to transmit over the unscheduled uplink channel and the mobile unit determines (at 450) that the transmit buffer in the mobile unit is empty or at a relatively low level, then the mobile unit may transmit (at 455) the acknowledgment or non-acknowledgment message using the pre-allocated resources of the unscheduled uplink channel using a relatively low order modulation scheme such as BPSK. However, if the mobile unit determines (at 460) that the transmit buffer in the mobile unit is full or at a relatively high level, then the mobile unit may transmit (at 465) a scheduling request and the acknowledgment or non-acknowledgment message using the resources allocated for transmission of the acknowledgment or non-acknowledgment message. For example, the signaling request and the acknowledgment or non-acknowledgment message may be modulated into one symbol using a relatively high order modulation scheme such as QPSK.

In some cases, the mobile unit may have to transmit more than one acknowledgment or non-acknowledgment message. For example, channel conditions may permit multiple downlink data streams to be directed to the mobile unit and so the mobile unit may need to acknowledge successful or unsuccessful reception of data blocks transmitted as part of the data streams. If the mobile unit determines (at 470) that there are two concurrent acknowledgment or non-acknowledgment messages to transmit over the unscheduled uplink channel, then the mobile unit may transmit (at 475) the multiple acknowledgment or non-acknowledgment messages using the resources allocated for transmission of a single acknowledgment or non-acknowledgment message. For example, the multiple acknowledgment or non-acknowledgment messages may be modulated into one symbol using a relatively high order modulation scheme such as QPSK. The scheduling request will thus have to be sent at a later point in time. Another approach is to dedicate more resources to the unscheduled channel in order to allow the mobile unit to transmit two ACK/NAKs and a scheduling request concurrently.

Embodiments of the techniques described herein support the transmission of scheduling requests from a mobile unit to a base station at arbitrary points in time via unscheduled uplink channels such as the PUCCH and scheduled uplink channels such as the PUSCH. These techniques may save a significant amount of processing resources in the base station for decoding the respective channels by avoiding the need for blind decoding. In contrast to conventional techniques that employ code multiplexing, the savings in processing resources does not increase the peak-to-average power ratio at the mobile station.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed:

1. A method, comprising:
determining, at a mobile unit, whether at least one first resource for transmission of a scheduling request over an unscheduled uplink control channel is allocated concurrently with at least one second resource for transmission of user data over a scheduled uplink shared channel; and
encoding, at the mobile unit and in response to determining that said at least one first resource is allocated concurrently with said at least one second resource, the user data and at least one bit to form encoded information for transmission using said at least one second resource, said at least one bit indicating whether the mobile unit is transmitting the scheduling request.

2. The method of claim 1, wherein determining that said at least one first resource is allocated concurrently with said at least one second resource comprises determining that a timeslot for transmission of the scheduling request is allocated concurrently with a timeslot for transmission of the user data.

3. The method of claim 1, wherein encoding the user data and said at least one bit comprises modifying a coding algorithm used to encode the user data and said at least one bit so that the encoded information indicative of the user data and said at least one bit can be transmitted over the scheduled uplink shared channel using said at least one second resource.

4. The method of claim 3, wherein encoding the user data and said at least one bit comprises using puncturing to encode the user data for transmission so that the encoded information indicative of the user data and said at least one bit can be transmitted over the scheduled uplink shared channel using said at least one second resource.

5. The method of claim 1, wherein encoding the user data and said at least one bit comprises encoding the user data and a plurality of bits indicative of at least one of a scheduling request, channel quality information, an acknowledgment message, and a non-acknowledgment message.

6. The method of claim 1, comprising transmitting the encoded information over the scheduled uplink shared channel using said at least one second resource.

7. A method, comprising:
determining, at the base station, whether at least one first resource for transmission of a scheduling request over an unscheduled uplink control channel is allocated concurrently with at least one second resource for transmission of user data over a scheduled uplink shared channel; and
decoding, at the base station and in response to determining that said at least one first resource is allocated concurrently with said at least one second resource, received information indicative of the user data and at least one bit, said at least one bit indicating whether a mobile unit is transmitting the scheduling request.

8. The method of claim 7, wherein determining that said at least one first resource is allocated concurrently with said at least one second resource comprises determining that a timeslot for transmission of the scheduling request is allocated concurrently with a timeslot for transmission of the user data.

9. The method of claim 7, wherein decoding the received information indicative of the user data and said at least one bit comprises decoding the received information using a coding algorithm selected to encode the user data and said at least one bit so that the encoded information indicative of the user data and said at least one bit can be transmitted over the scheduled uplink shared channel using said at least one second resource.

10. The method of claim 9, wherein decoding the received information indicative of the user data and said at least one bit comprises decoding the received information that was encoded using at least one of puncturing or repetition.

11. The method of claim 7, comprising determining whether the mobile unit transmitted at least one of a scheduling request, channel quality information, an acknowledgment message, and a non-acknowledgment message based upon said at least one decoded bit.

12. A method, comprising:
determining, at a mobile unit, whether at least one first resource for transmission of a scheduling request over an unscheduled uplink control channel is allocated concurrently with at least one second resource for transmission of other control information over the unscheduled uplink control channel; and
modulating, at the mobile unit and in response to determining that said at least one first resource is allocated concurrently with said at least one second resource, the scheduling request and the other control information into one symbol for transmission using said at least one second resource.

13. The method of claim 12, wherein determining whether said at least one first resource is allocated concurrently with said at least one second resource comprises determining that transmission of the scheduling request is scheduled concurrently with transmission of at least one of an acknowledgment message or a non-acknowledgment message.

14. The method of claim 12, wherein modulating the scheduling request and the other control information comprises modulating the scheduling request and the other control information using a higher order modulation scheme than the modulation scheme used to modulate the other control information alone to form modulated information for transmission using said at least one second resource.

15. The method of claim 12, wherein modulating the scheduling request and the other control information comprises allocating a larger resource to accommodate scheduling requests and other control information.

16. The method of claim 12, wherein modulating the scheduling request and the other control information comprises modulating the scheduling request and the other control information using a multiplexing scheme that avoids increasing the peak-to-average power ratio.

17. The method of claim 12, comprising transmitting information indicative of the symbol over the unscheduled uplink control channel using said at least one second resource.

18. A method, comprising:
determining, at a base station, whether at least one first resource for transmission of a scheduling request over an unscheduled uplink control channel is allocated concurrently with at least one second resource for transmission of other control information over the unscheduled uplink control channel; and
demodulating, at the base station and in response to determining that said at least one first resource is allocated concurrently with said at least one second resource, a symbol comprising information indicative of the scheduling request and the other control information, the symbol being received over the unscheduled uplink control channel using said at least one second resource.

19. The method of claim 18, wherein determining whether said at least one first resource is allocated concurrently with said at least one second resource comprises determining that transmission of the scheduling request is scheduled concurrently with transmission of at least one of an acknowledgment message and a non-acknowledgment message.

20. The method of claim 18, wherein demodulating the received symbol comprises demodulating the received symbol using a higher order modulation scheme than a modulation scheme used to modulate the other control information alone to form a symbol for transmission using said at least one second resource.

21. The method of claim 17, wherein demodulating the received modulated information comprises demodulating the received symbol that is multiplexed with a scheme that avoids increasing the peak-to-average power ratio.

22. A mobile unit, comprising:
a processing unit configured to:
determine whether at least one first resource for transmission of a scheduling request over an unscheduled uplink control channel is allocated concurrently with at least one second resource for transmission of user data over a scheduled uplink shared channel; and
encode, in response to determining that said at least one first resource is allocated concurrently with said at least one second resource, the user data and at least one bit to form encoded information for transmission using said at least one second resource, said at least one bit indicating whether the mobile unit is transmitting the scheduling request.

23. A base station, comprising:
a processing unit configured to:
determine whether at least one first resource for transmission of a scheduling request over an unscheduled uplink control channel is allocated concurrently with at least one second resource for transmission of user data over a scheduled uplink shared channel; and
decode, in response to determining that said at least one first resource is allocated concurrently with said at least one second resource, received information indicative of the user data and at least one bit, said at least one bit indicating whether a mobile unit is transmitting the scheduling request.

24. A mobile unit, comprising:
a processing unit configured to:
determine whether at least one first resource for transmission of a scheduling request over an unscheduled uplink control channel is allocated concurrently with at least one second resource for transmission of other control information over the unscheduled uplink control channel; and
modulate, in response to determining that said at least one first resource is allocated concurrently with said at least one second resource, the scheduling request and the other control information into one symbol for transmission using said at least one second resource.

25. A base station, comprising:
a processing unit configured to:
determine whether at least one first resource for transmission of a scheduling request over an unscheduled uplink control channel is allocated concurrently with at least one second resource for transmission of other control information over the unscheduled uplink control channel; and
demodulate, in response to determining that said at least one first resource is allocated concurrently with said at least one second resource, a symbol comprising information indicative of the scheduling request and the other control information, the symbol being received over the unscheduled uplink control channel using said at least one second resource.
